(19) United States
(12) Patent Application Publication
(10) Pub. No.: US 2025/0390235 A1
(43) Pub. Date: Dec. 25, 2025

(54) SECURE READBACK FROM CONFIGURATION MEMORY

(71) Applicant: Xilinx, Inc., San Jose, CA (US)

(72) Inventors: Bharath Mulagondla, Hyderabad (IN); V N S L Durga Challa, Hyderabad (IN); Mounika Akula, Hyderabad (IN)

(73) Assignee: Xilinx, Inc., San Jose, CA (US)

(21) Appl. No.: 18/753,287

(22) Filed: Jun. 25, 2024

(51) Int. Cl. G06F 3/06

(52) U.S. Cl. CPC G06F 3/0629; G06F 3/0604; G06F 3/0673

(57) ABSTRACT

Multiple semiconductor dice are disposed on a silicon interposer and are communicatively coupled via the interposer. A first die includes a first memory and a readback circuit, which is coupled to the first memory and coupled to receive a readback command communicated through the interposer. A hash circuit on the first die is configured to generate a message digest from data in the first memory, and an encryption circuit on the first die is configured to encrypt the message digest into an encrypted message digest. The encrypted message digest is accessible through the interposer.

### TECHNICAL FIELD

The disclosure generally relates to securely obtaining the state of a configuration memory.

### BACKGROUND

Proper functioning of an application implemented on a programmable logic device (PLD) depends on the configuration memory having a state that is consistent with the configuration bitstream generated by design tools. The source of error in a malfunctioning PLD-implemented application can be a design error or a corrupted configuration memory. Before attempting to locate a design error, it is desirable to first verify that the configuration memory has not been corrupted.

Verifying a proper configuration has involved reading back the state of the memory and comparing the readback data to a “golden” bitstream. The golden bitstream is a copy of the bitstream used in configuring the PLD and known to be valid. In an effort to avoid exposure of proprietary information to untrusted parties, readback is generally disabled to end users. Readback is enabled only for authorized persons, making verification cumbersome. In addition, reading the state of the configuration memory can be time consuming for large configuration memories.

### SUMMARY

An integrated circuit device includes a silicon interposer and a plurality of semiconductor dice disposed on the interposer. The dice are communicatively coupled via the interposer. A first die of the plurality of dice includes a first memory and a readback circuit coupled to the first memory and coupled to receive a readback command communicated through the interposer. The first die includes a hash circuit coupled to the readback circuit and configured to generate a message digest from data in the first memory. The first die includes an encryption circuit coupled to the hash circuit and readback circuit and configured to encrypt the message digest into an encrypted message digest. The encrypted message digest is accessible through the interposer.

A method includes receiving, by a readback circuit configured on a first die that is disposed on a silicon interposer, a readback command communicated through the interposer. A plurality of semiconductor dice are disposed on the interposer and communicatively coupled via the interposer. The method includes generating by a hash circuit configured on the first die, a message digest from data in a first memory configured on the first die. The method includes encrypting the message digest into an encrypted message digest by an encryption circuit configured on the first die. The method includes transmitting the encrypted message digest through the interposer.

Other features will be recognized from consideration of the Detailed Description and Claims, which follow.

### BRIEF DESCRIPTION OF THE DRAWINGS

Various aspects and features of the circuits and methods will become apparent upon review of the following detailed description and upon reference to the drawings in which:

FIG. 1 shows an example of an integrated circuit device having multiple semiconductor dice mounted on an interposer and communicatively coupled via the interposer;

FIG. 2 shows an example of secure readback logic for configuration memory associated with programmable logic;

FIG. 3 shows an example having a master super logic region (MSLR) and multiple slave SLRs (SSLRs); and

FIG. 4 shows a process flow diagram of an example in which a host computer system requests readback from a configuration memory of an SSLR followed by a request for readback from the MSLR.

### DETAILED DESCRIPTION

In the following description, numerous specific details are set forth to describe specific examples presented herein. It should be apparent, however, to one skilled in the art, that one or more other examples and/or variations of these examples, all of which are non-limiting, may be practiced without all the specific details given below. In other instances, well known features have not been described in detail so as not to obscure the description of the examples herein. For ease of illustration, the same reference numerals may be used in different diagrams to refer to the same elements or additional instances of the same element.

The structural features of some programmable devices can contribute to relatively slow and insecure readback of configuration data. For example, programmable devices from Xilinx, Inc., have multiple super logic regions (SLRs), each of which has its own configuration memory and is disposed on a separate semiconductor die. The dice are mounted on a silicon interposer and communicatively coupled via the interposer. Readback of the configuration data from the SLRs is performed sequentially, which slows the readback process. The data is transmitted via the interposer and can create a security risk.

According to the disclosed approaches, instead of reading back plaintext configuration data, the configuration data is subjected to a cryptographic hash, such as the Secure Hash Algorithm 3 (“SHA3”), and the resulting message digest is encrypted, using Advanced Encryption Standard-Galois Counter Mode (AES-GCM) encryption, for example. The encrypted message digest is transmitted through the interposer instead of plaintext configuration data. This approach significantly reduces the amount of data to be transmitted off-device, and the configuration data is protected by transmitting only the encrypted message digest through the interposer.

A trusted party can possess a copy of the message digest known to be valid (“golden message digest”) along with the key to decrypt the encrypted message digest obtained from the device. The decrypted message digest can be compared to the golden message digest to determine whether or not the state of the configuration memory has been corrupted.

Instead of receiving the entire plaintext configuration data, the trusted party receives the encrypted digest. As a result, the verification process is made simpler and the transfer time is reduced because very little data is transferred compared to the plaintext configuration data. For example, in some devices the size of the plaintext configuration can be about 80 Mb. The disclosed approaches can reduce the size to a fixed size of 64 bytes (Encrypted digest (48 Bytes)+GCM Tag (16 Bytes).

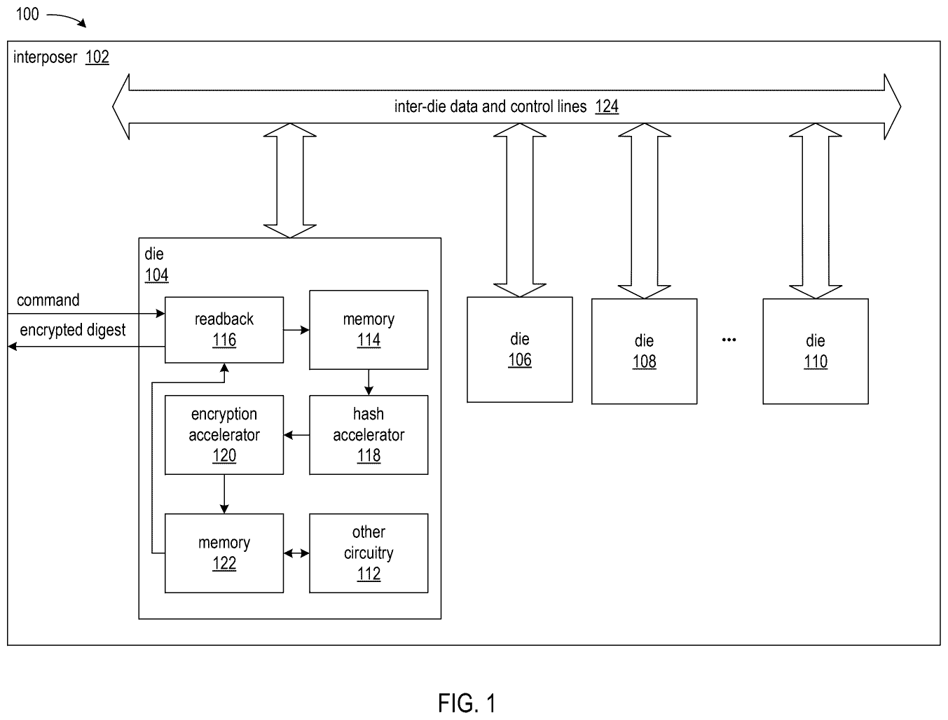

FIG. 1 shows an example of an integrated circuit device 100 having multiple semiconductor dice mounted on an interposer and communicatively coupled via the interposer. One or more of the dice is configured to input a command from off-device. The command requests information describing the state of a memory, and circuitry on the die is configured to generate an encrypted message digest from data in the memory on the die. The encrypted message digest is output through the interposer.

The exemplary integrated circuit device 100 includes a silicon interposer 102 and multiple integrated circuit dice 104, 106, 108, . . . 110 disposed thereon. The dice are communicatively coupled by data and control lines 124 formed within and/or on the interposer.

In the exemplary device, die 104 includes memory 114 and memory 122. Memory 114 can be a memory in which all or a portion has a static state, such as configuration memory associated with programmable logic. Memory 122 is used by other circuitry 112 of the die, such as microprocessors and programmed logic. The state of memory 122 is expected to be dynamic based on the functions of circuitry 112.

Die 104 includes circuitry for securely obtaining the state of memory 114. Readback circuit 116, in response to an input command that requests secure readback, signals hash accelerator 118 to begin performing a cryptographic hash on data read from memory 114 as instructed by the readback circuit. Encryption accelerator 120 receives the message digest from the hash accelerator and encrypts the message digest. The encrypted message digest can be streamed output through the interposer by the readback circuit 116 or written to memory 122 to be subsequently accessed by a system external to the device 100.

In an example, the hash accelerator 118 can perform the SHA3 cryptographic hash algorithm, and the encryption accelerator 120 can perform AES-GCM encryption using a die-specific key. The accelerators can be implemented by one or more microprocessors and/or application specific integrated circuitry.

In some applications, dice 106, 108, . . . , and/or 110 can have instances of the readback circuit 116, memory 114, hash accelerator 118, encryption accelerator 120, other circuitry 112, and memory 122. In those applications, the cryptographic hashing of the states of the memories on the multiple dice can be performed concurrently. Similarly, encryption of the message digests on the dice can be performed concurrently. Each die can have a die-specific encryption key used for encryption by the encryption accelerator. In one example, each die-specific encryption key can be configured in eFuses on the die.

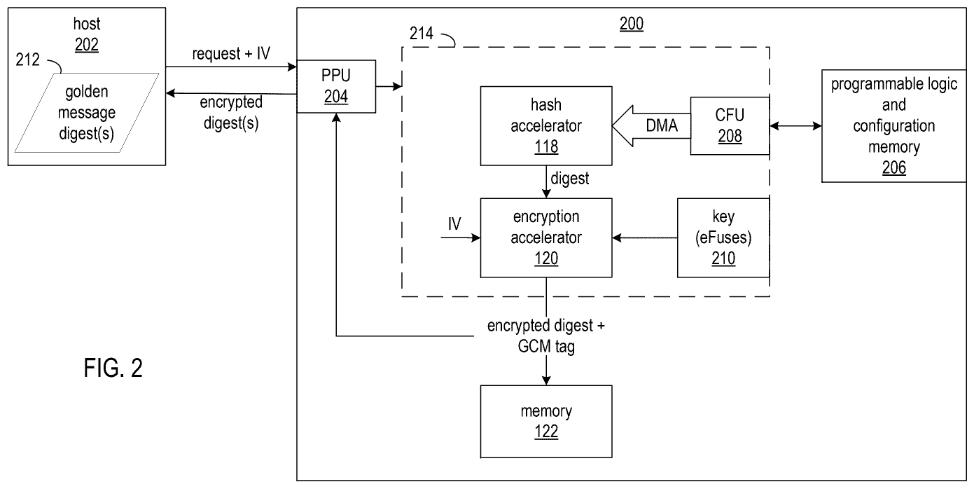

FIG. 2 shows an example of secure readback logic 214 for configuration memory associated with programmable logic. The readback logic is shown as part of a super logic region (SLR) 200 in a programmable device from Xilinx, Inc., for example. An SLR is a single device die slice disposed on a silicon interposer, which can support multiple SLRs. Each SLR contains resources (not shown), such as configurable logic blocks (CLBs), block RAMs, digital signal processing (DSP) tiles, and gigabit transceivers (GTs).

The CLBs and other configurable resources can also referred to as “programmable logic.” The programmable logic is scalable to provide the ability to create many possible functions by programming the configuration memory. The programmable logic and associated configuration memory are shown as block 206. The programmable logic regions include building blocks and interfaces to a network-on-chip, input/output pins, and in some cases a processing system. Writing to and reading from the configuration memory is controlled by the configuration frame unit (CFU) 208.

Host data processing system 202 can be configured with verification software (not shown). Execution of the verification software can initiate readback of the state of memory 206 of SLR 200 and optionally other SLRs. Once the verification software receives the encrypted message digest(s), the verification software can decrypt the encrypted message digest(s) using a host-stored copy of the die-specific key(s), and then compare the message digest(s) to host-stored golden message digest(s) 212. The verification software can initiate remedial actions in response to finding the configuration memory in an invalid state. For example, in response to the readback message digest being not equal to the golden message digest, the verification software can signal the device to place itself in lockdown or signal the device to reset. In response to the readback message digest being equal to the golden message digest, the verification software can output a message indicating that the configuration memory is in a valid state.

The platform processing unit (PPU) 204 normally is a processor that runs platform loader and manager (PLM) firmware. The PLM configures the system, e.g., system-on-chip, downloads boot image files, monitors the system, and provides platform services. The resources available to the PPU firmware include security, power control, error detection, and functional safety features.

The PPU 204 is coupled to receive commands from the host 202. A readback command can be received by the PPU through a dedicated configuration interface, such as the SelectMAP interface on Xilinx devices, or through a general purpose bus interface such as a “PCIE” (Peripheral Component Interface Extended) bus. A readback command requests readback of the state of configuration memory 206 and includes an initialization vector (IV). The readback command can also specify identifiers of one or more dice from which the state(s) of configuration memory(s) is to be obtained.

The PPU controls CFU 208 to read data from configuration memory, enables the hash accelerator 118 to begin computing a cryptographic hash from data, and provides the IV to encryption accelerator 120. The encryption accelerator 120 encrypts the message digest using the IV and the key 210, which can be configured in eFuses of the SLR. For a readback command received via SelectMAP, the PPU controls “DMA” (direct memory access) access to stream the encrypted message digest directly through SelectMAP interface. For a readback command received via a PCIE or similar bus, the PPU controls writing of the encrypted message digest to memory 122.

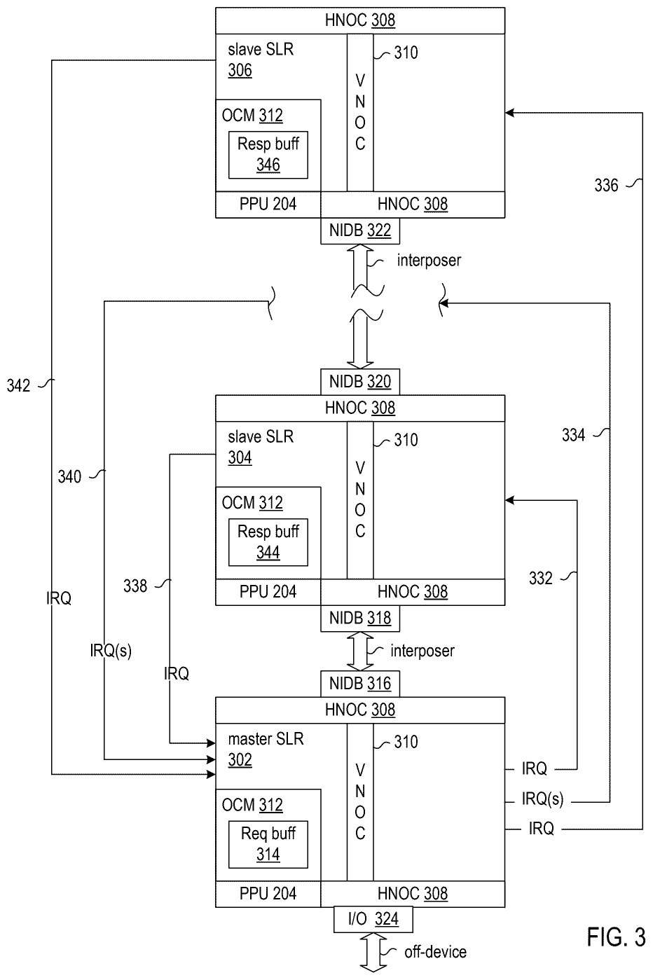

FIG. 3 shows an example having a master super logic region (MSLR) 302 and multiple slave SLRs (SSLRs) 304, . . . , 306. Each SLR includes a PPU 204, a horizontal network-on-chip (HNOC) 308, a vertical NoC (VNOC) 310, and an on-chip memory (OCM) 312.

The SLRs include one or more NoC Inter-Die Bridges (NIDBs) that enable communication between SLRs through the interposer. MSLR 302 includes NIDB 316, which is coupled through the interposer to NIDB 318 of SSLR 304. SSLR 304 also includes NIDB 320, which is coupled to the NIDB (not shown) of the next SSLR (not shown) in the chain. SSLR 306 includes NIDB 322, which is coupled to the previous SSLR (not shown) in the chain. The MSLR can be additionally coupled to the SSLRs by side-channel lines (bypassing NoCs) for sending and receiving interrupt signals, as shown by signal lines 332, 334, 336, 338, 340, and 342.

In response to input of a readback command, the MSLR decodes the request and writes the command to the request buffer 314 in the OCM 312. Based on the SLR identifier(s) specified in the command, the PPU of the MSLR generates one or more parallel interrupt signals to the PPU(s) of the specified SSLR(s). In response to a readback interrupt from the MSLR, an SSLR reads the command from the MSLR request buffer 314. Read requests and data from the request buffer are transmitted through the interposer and via the HNOCs and VNOCs of the SLRs.

The SLRs operate concurrently in performing the cryptographic hashes and encrypting the respective message digests. As explained above, each SLR has a die-specific key used by its encryption accelerator. Each SSLR writes its generated encrypted message digest to its local response buffer. For example, SSLR 304 writes its encrypted message digest to response buffer 344, and SSLR 306 writes its encrypted message digest to response buffer 346. After writing its encrypted message digest to its response buffer, an SSLR generates an interrupt signal to the MSLR 302 to indicate that the encrypted message digest is read to be read by the MSLR and output for validation. The reading of the encrypted message digest(s) by the MSLR from the response buffers is through the interposer and via HNOCs and VNOCs. Depending on the channel through which the MSLR received the readback command, the encrypted message digest of the MSLR can be streamed out directly or first written to a buffer in its OCM 312.

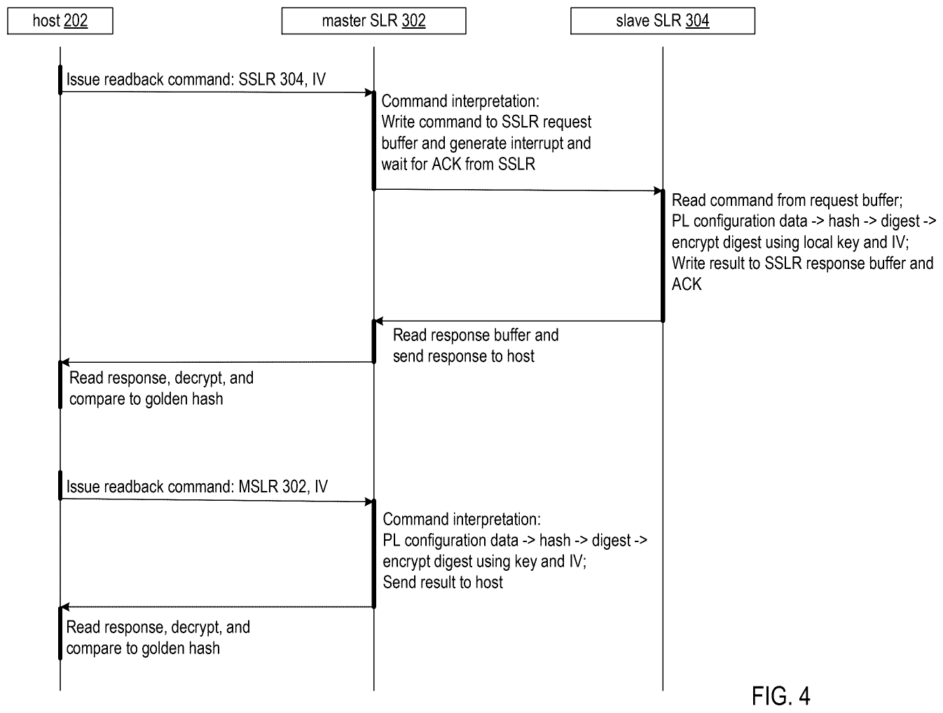

FIG. 4 shows a process flow diagram of an example in which a host computer system 202 requests readback from a configuration memory of an SSLR 304 followed by a request for readback from the MSLR 302. The vertical lines show relative timelines of processing by the components, and the thick portions of the timelines correspond to the processing described by the adjacent text.

The host issues a readback command, which includes an identifier of SSLR 304 and an IV. In interpreting the command, MSLR 302 writes the command to its request buffer at an address associated with the referenced SSLR 304 and generates an interrupt to SSLR 304. MSLR 302 then waits for acknowledgment from SSLR 304 that the encrypted message digest is ready.

In response to the interrupt from MSLR 302, SSLR 304 reads the command from the MSLR request buffer and initiates readback processing. As described above, readback processing by the SSLR includes reading data from the configuration memory, performing a cryptographic hash on the data, encrypting the message digest using a device-specific key and IV from the readback command, and writing the encrypted message digest to the response buffer of the SSLR. Once complete, by way of an interrupt signal to the MSLR, the SSLR acknowledges that the encrypted message digest is ready in the response buffer for the MSLR.

In response to the interrupt from SSLR 304, MSLR 302 reads the encrypted message digest from the response buffer of the SSLR and sends the encrypted message digest to the host 202. In response to receiving the encrypted message digest from the MSLR, the host decrypts the encrypted message digest using a copy of the key used by SSLR 304 and compares the decrypted message digest to the corresponding golden message digest to determine whether or not the state of the configuration memory is valid.

The example continues with the host issuing a second readback command, which specifies the identifier of MSLR 302 and the IV. In interpreting the command, MSLR 302 initiates reading of data from MSLR configuration, computes a cryptographic hash of the data, and encrypts the message digest using the MSLR device-specific key and the IV from the readback command. The MSLR sends the encrypted message digest to the host, and the host determines validity of the state of the MSLR configuration memory as described above.

Various logic may be implemented as circuitry to carry out one or more of the operations and activities described herein and/or shown in the figures. In these contexts, a circuit or circuitry may be referred to using terms such as “logic,” “module,” “engine,” “generator,” or “block.” It should be understood that elements labeled by these terms are all circuits that carry out one or more of the operations/activities. In certain implementations, a programmable circuit is one or more computer circuits programmed to execute a set (or sets) of instructions stored in a ROM or RAM and/or operate according to configuration data stored in a configuration memory.

Though aspects and features may in some cases be described in individual figures, it will be appreciated that features from one figure can be combined with features of another figure even though the combination is not explicitly shown or explicitly described as a combination.

The circuitry and methods are thought to be applicable to a variety of systems for obtaining configuration data from an integrated circuit device. Other aspects and features will be apparent to those skilled in the art from consideration of the specification. The circuitry and methods can be implemented as one or more processors configured to execute software, as an application specific integrated circuit (ASIC), or as a logic on a programmable logic device. It is intended that the specification and drawings be considered as examples only, with a true scope of the invention being indicated by the following claims.

What is claimed is:

1. An integrated circuit device, comprising:
a silicon interposer;
a plurality of semiconductor dice disposed on the interposer and communicatively coupled via the interposer, wherein a first die of the plurality of dice includes:
a first memory;
a readback circuit coupled to the first memory and configured to receive a readback command communicated through the interposer;
a hash circuit coupled to the readback circuit and configured to generate a message digest from data in the first memory; and
an encryption circuit coupled to the hash circuit and readback circuit and configured to encrypt the message digest into an encrypted message digest;
wherein the encrypted message digest is accessible through the interposer.

2. The device of claim 1, wherein in addition to the first die, the plurality of dice includes two or more additional dice, and each die of the two or more additional dice includes a respective first memory, a respective readback circuit, a respective hash circuit, and a respective encryption circuit.

3. The device of claim 2, wherein the hash circuits on the first die and the two or more additional dice are configured to concurrently generate respective message digests.

4. The device of claim 3, wherein the respective encryption circuits on the first die and the two or more additional dice are configured to concurrently encrypt the respective message digests.

5. The device of claim 3, wherein the encryption circuits on the first die and the two or more additional dice are configured to use die-specific keys to encrypt the respective message digests.

6. The device of claim 5, wherein the die-specific keys are configured in eFuses on the first die and the two or more additional dice.

7. The device of claim 2, wherein:
the plurality of dice includes a second die in addition to the first die and the two or more additional dice;
the second die is configured to receive a master readback command from off-device, and the master readback command specifies one or more of the first die and the two or more additional dice; and
the second die includes a master readback circuit configured to signal the one or more of the first die and the two or more additional dice that respective readback commands are available in response to the master readback command, and to receive each encrypted message digest from the one or more of the first die and the two or more additional dice through the interposer.

8. The device of claim 1, wherein the first die includes:
a second memory; and
wherein the encryption circuit is configured to write the encrypted message digest in the second memory.

9. The device of claim 8, wherein in addition to the first die, the plurality of dice includes two or more additional dice, and each die of the two or more additional dice includes a respective first memory, a respective second memory, a respective readback circuit, a respective hash circuit, and a respective encryption circuit.

10. The device of claim 9, wherein:
the plurality of dice includes a second die in addition to the first die and the two or more additional dice;
the second die is configured to receive a master readback command from off-device, and the master readback command specifies one or more of the first die and the two or more additional dice; and
the second die includes a master readback circuit configured to signal the one or more of the first die and the two or more additional dice that respective readback commands are available in response to the master readback command, and to read each encrypted message digest from the second memory of the one or more of the first die and the two or more additional dice through the interposer.

11. The device of claim 1, wherein each die of the plurality of dice includes programmable logic, and the first memory is a configuration memory of the programmable logic.

12. The device of claim 1, wherein the readback command includes an initialization vector, and the encryption circuit uses the initialization vector in Advanced Encryption Standard-Galois Counter Mode (AES-GCM) encryption.

13. The device of claim 1, wherein the hash circuit implements a Secure Hash Algorithm (SHA).

14. A method comprising:
receiving, by a readback circuit configured on a first die that is disposed on a silicon interposer, a readback command communicated through the interposer, wherein a plurality of semiconductor dice are disposed on the interposer and communicatively coupled via the interposer;
generating by a hash circuit configured on the first die, a message digest from data in a first memory configured on the first die;
encrypting the message digest into an encrypted message digest by an encryption circuit configured on the first die; and
transmitting the encrypted message digest through the interposer.

15. The method of claim 14, wherein in addition to the first die, the plurality of dice includes two or more additional dice, and each die of the two or more additional dice includes a respective first memory, a respective readback circuit, a respective hash circuit, and a respective encryption circuit, the method further comprising:
on each of the two or more additional dice:
receiving, by the respective readback circuit, a respective readback command communicated through the interposer;
generating by the respective hash circuit, a respective message digest from data in the respective first memory; and
encrypting the respective message digest into a respective encrypted message digest by the respective encryption circuit; and
transmitting the respective encrypted message digest through the interposer.

16. The method of claim 15, wherein generating the respective message digests is performed concurrently.

17. The method of claim 16, wherein encrypting the respective message digests is performed concurrently.

18. The method of claim 16, wherein encrypting the respective message digests includes encrypting the respective message digests using die-specific keys.

19. The method of claim 16, wherein encrypting the respective message digests includes encrypting the respective message digests using die-specific keys configured in eFuses on the first die and the two or more additional dice.

20. The method of claim 15, further comprising:
receiving a master readback command through the interposer by a second die of the plurality of dice, wherein the master readback command specifies one or more of the first die and the two or more additional dice;
signaling, by a master readback circuit configured on the second die, the one or more of the first die and the two or more additional dice that respective readback commands are available in response to the master readback command; and
receiving the respective encrypted message digests from the one or more of the first die and the two or more additional dice through the interposer by the master readback circuit.
